(19) United States
(12) Patent Application Publication
(10) Pub. No.: US 2012/0240018 A1
(43) Pub. Date: Sep. 20, 2012

(54) Method of Collecting Photographs for a Picture Portion of a Commemorative Publication with a Plurality of Digital Photo-Enabled Electronic Devices

(76) Inventor: Donte Deshon PITCHFORD, Snellville, GA (US)

(21) Appl. No.: 13/420,570

(22) Filed: Mar. 14, 2012

Related U.S. Application Data
(60) Provisional application No. 61/452,542, filed on Mar. 14, 2011.

(51) Int. Cl. G06F 17/00

(52) U.S. Cl. 715/202

(57) ABSTRACT

A publishing company follows a process to collect photographs for a picture portion of a commemorative publication with a plurality of digital photo-enabled electronic devices. First, the publishing company should provide a website for an event coordinator to view their photo collecting service. Once the event coordinator agrees to the photo collecting service, the publishing company provides the event coordinator with a phone number and an email address that are specific to the event coordinator. The event coordinator then distributes the phone number and the email address to the guests at the event so that the guests can take pictures with their digital photo-enabled electronic devices and send those pictures back to the publishing company. The publishing company stores the collection of photographs, which were taken by the guests, to a database server. Finally, the collection of photographs can be used to create the picture portion of the commemorative publication.

The current application claims a priority to the U.S. Provisional Patent application Ser. No. 61/452,542 filed on Mar. 14, 2011.

### FIELD OF THE INVENTION

The present invention relates generally to a method for picture messaging. More particularly, the present invention provides mobile communication for sending and receiving pictures of multimedia for recording a time-framed event.

### BACKGROUND OF THE INVENTION

Time-framed events including but not excluded to a year or years, seasons, hours, and minutes can be recorded using a camera. Many of these moments or events are collectively captured in a yearbook, blog, event datebook, or any other collections of photographs. However, the conventional method for recording and presenting such multimedia involves using a manual or digital camera. There currently exists no method for composing a collection of photographs and memories which involves receiving picture texts via mobile communication. It is therefore an object of the present invention to introduce a method for sending and receiving pictures of multimedia for recording a time-framed event using mobile communication.

### BRIEF DESCRIPTION OF THE DRAWINGS

FIG. 1 is a flow chart depicting the process followed by the publishing company during the method of the present invention.

FIG. 2 is a flow chart depicting a continuation of the process followed by the publishing company during the method of the present invention.

FIG. 3 is a flow chart depicting the exchange of information between the publishing company, the event coordinator, and the multiple persons at the special event.

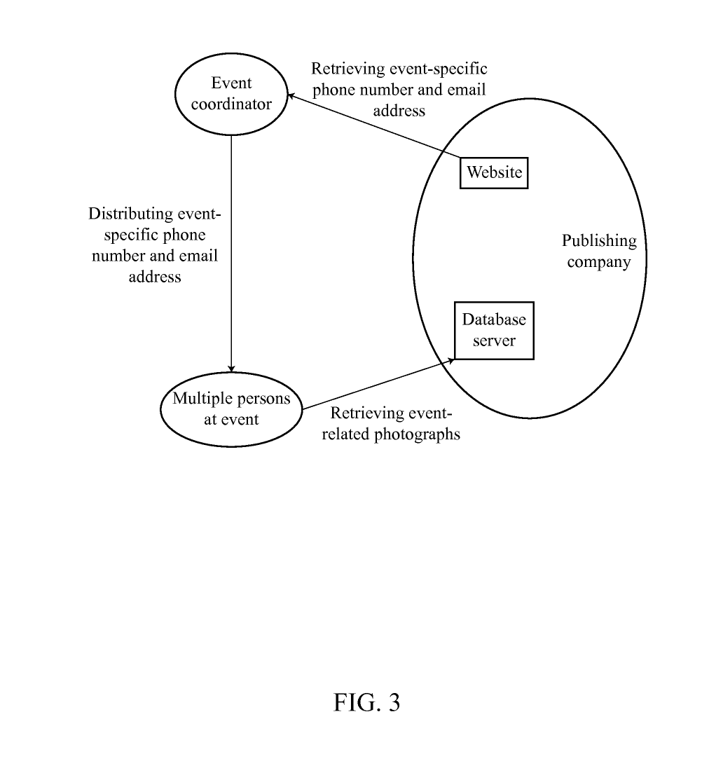

### DETAIL DESCRIPTIONS OF THE INVENTION

All illustrations of the drawings are for the purpose of describing selected versions of the present invention and are not intended to limit the scope of the present invention.

The present invention is a method to collect photographs for the picture portion of a commemorative publication, which can be either a magazine or a book that commemorates a special event such as a school year, a wedding, a Bar Mitzvah, a family reunion, or a conference. The commemorative publication is designed and created by a publishing company that collects the photographs from multiple persons attending or taking part in the special event. The multiple persons can capture and electronically send the photographs through digital photo-enabled electronic devices such as a cellular phone, a digital camera, a Bluetooth camera, a laptop, or a desktop. The present invention does not limit the photographs being taken at a special event to a couple of people or to a profession photographer. The present invention allows everyone at the special event to contribute photographs to the picture portion of the commemorative publication. The special event will also occur over a time period. For example, the time period for a yearbook is the school year. The time period defines how long the publishing company should continue to collect photographs from the multiple persons. The time period for a special event can be any length of time such as one year, multiple years, seasonal period, one day, or even one hour.

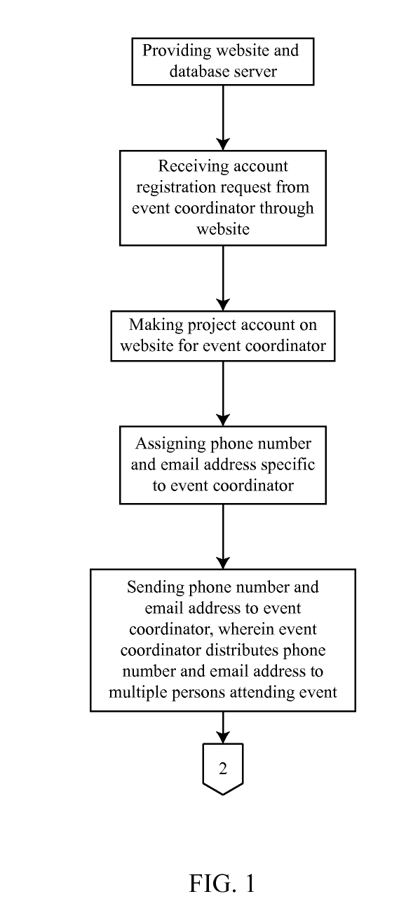

As can be seen in FIG. 1, the process that is followed by the present invention is executed by the publishing company. The first step of the process is to provide a website that allows an event coordinator to view and understand the photo collecting service provided by the publishing company. The event coordinator is the person or persons that is organizing and planning a particular special event. The next step is that the publishing company should receive an account registration request through their website once the event coordinator decides to use the photo collecting service provided by the publishing company. The account registration request allows the publishing company to make a project account on the website for that particular special event. The project account allows the publishing company to keep track of all information related to that particular special event. The event coordinator can also use the project account to monitor the progress of the photo collecting service. In addition, the event coordinator can download a custom software to further monitor the progress of the photo collecting service. The next step is to assign a project telephone number and a project email address that are particular to the project account. The project telephone number and the project email address are the contact information required by the multiple persons attending or taking part in the special event to electronically send the event-related photographs back to the publishing company. The process continues by sending the project telephone number and the project email address to the event organizer so that the event organizer can distribute them to the multiple persons attending or taking part in the special event.

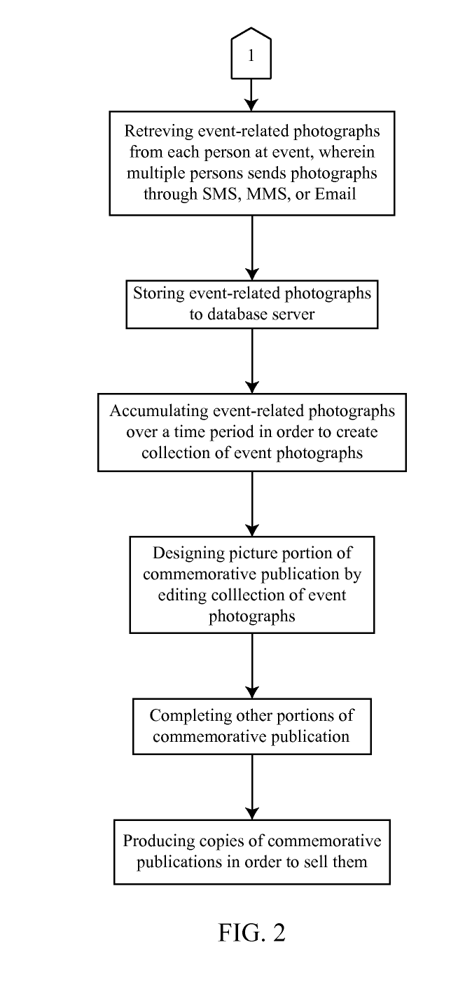

Once that particular special event begins, the publishing company receives event-related photographs from the multiple persons through either the project telephone number or the project email address, which is shown in FIG. 2. One way that the multiple persons can electronically send the event-related photographs to the publishing company is to use Short Message Service (SMS) or Multimedia Message Service (MMS) with the project telephone number. Another way that the multiple persons can sent the event-related photographs to the publishing company is to use an internet-enabled device in order to electronically mail (Email) them. The process continues by storing all of the event-related photographs onto the publishing company's database server. Each person at the special event can send an unlimited amount of event-related photographs. The database server accumulates the event-related photographs from each of the multiple persons over a time period, which creates a collection of event photographs for the special event. The collection of event photographs is all of the event-related photographs taken by all of the multiple persons during the entire time period of the special event. The publishing company can then edit, censor, and modify the collection of event photographs to design the picture portion of the commemorative publication. The publishing company will also have to complete the other portions of the commemorative publication such as the written portion, the typesetting, and the proofreading. In different embodiment of the present invention, the other portions of the commemorative publication could also include Quick Response (QR) codes, which are placed adjacent to a picture on the pages of the commemorative publication. If the user scans a QR code, then the user can view a video on the website, which relates to the picture adjacent to the QR code. Finally, the publishing company will produce copies of the commemorative publication in order to sell them to the multiple persons and anyone else willing to buy a copy. The publishing company also allows a buyer to purchase a personalized copy of the commemorative publication through their packed service options. One such service option is to create an internet webpage from the commemorative publication instead of a physical magazine or book.

The present invention is designed to accommodate two primary embodiments of the commemorative publication. One primary embodiment of the commemorative publication is a school yearbook. The event coordinator can purchase the photo collecting service from the publishing company at the beginning of the school year. The event coordinator can then distribute the project phone number and the project email address to the students attending a particular school during that school year. In this embodiment of the commemorative publication, the time period for collecting photographs is the length of the school year. The other primary embodiment of the commemorative publication is a magazine or a book depicting a celebratory gathering such as a wedding, a Bar Mitzvah, or a family reunion. The event coordinator can purchase the photo collecting service from the publishing company before the celebratory gathering. The event coordinator can then distribute the project phone number and the project email address to the guests at the beginning of the celebratory gathering. In this embodiment of the commemorative publication, the time period for collecting photographs is the length of the commemorative publication.

Although the invention has been explained in relation to its preferred embodiment, it is to be understood that many other possible modifications and variations can be made without departing from the spirit and scope of the invention as hereinafter claimed.

What is claimed is:

1. A method of collecting photographs for a picture portion of a commemorative publication with a plurality of digital photo-enabled electronic devices comprises the steps of:
providing a website and a database server, wherein said website and the database server is managed by a publishing company;
receiving an account registration request from an event coordinator through said website;
making a project account on said website for said event coordinator;
assigning said project account with a project telephone number and a project email address;
retrieving contact information from said event coordinator;
sending a project telephone number and a project email address to said event coordinator, wherein said event coordinator distributes said project telephone number and said project email number to multiple persons;
retrieving event-related photographs from each of said multiple persons through said project telephone number and said project email address, wherein said multiple persons sends said event-related photographs through Short Message Service (SMS), Multimedia Message Service (MMS), or Electronic Mail (Email);
storing said event-related photographs on said database server;
accumulating said event-related photographs from each of said multiple persons over a time period in order to create a collection of event photographs;
designing a picture portion of a commemorative publication by editing said collection of event photographs;
completing other portions of said commemorative publication; and
producing copies of the commemorative publication in order to sell the commemorative publication.

2. The method of collecting photographs for a picture portion of a commemorative publication with a plurality of digital photo-enabled electronic devices of claim 1, wherein digital photo-enabled electronic devices include mobile cellular phones, tablet personal computers, laptops, desktops, and digital cameras.

3. The method of collecting photographs for a picture portion of a commemorative publication with a plurality of digital photo-enabled electronic devices of claim 1, wherein said commemorative publication is a school yearbook and said time period is a school year.

4. The method of collecting photographs for a picture portion of a commemorative publication with a plurality of digital photo-enabled electronic devices of claim 3, wherein said multiple persons are students attending a particular school during said school year.

5. The method of collecting photographs for a picture portion of a publication with a plurality of digital photo-enabled electronic devices of claim 1, wherein said commemorative publication is a personalized magazine for a celebratory gathering and said time period is length of said celebratory gathering.

6. The method of collecting photographs for a picture portion of a commemorative publication with a plurality of digital photo-enabled electronic devices of claim 5, wherein said multiple persons are guests at said celebratory gathering.
